(19) United States
(12) Patent Application Publication
(10) Pub. No.: US 2011/0036197 A1
(43) Pub. Date: Feb. 17, 2011

(54) CLAMPING DEVICE AND TRANSFER ROBOT

(75) Inventors: Sota Aoki, Aichi (JP); Koji Tomida, Aichi (JP); Shinji Tohyama, Aichi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi, Aichi (JP)

(21) Appl. No.: 12/922,999

(22) PCT Filed: Mar. 18, 2009
(86) PCT No.: PCT/JP2009/055291

§ 371 Date: Sep. 16, 2010

(30) Foreign Application Priority Data
Mar. 21, 2008 (JP) 2008-073833

(51) Int. Cl. B25J 18/06

(52) U.S. Cl. 74/490.01; 294/106

(57) ABSTRACT

To provide a clamping device capable of clamping an object even when variations are large, and a wheeled platform. A clamping device 10 includes an actuator that moves straight, a link 2 that extends in a direction perpendicular to a straight-movement direction of the actuator, and a clamp portion 3 rotatably attached at both ends of the link 2, the clamp portion comprising a nail portion 3a to clamp a portion to be clamped 8. The actuator moves straight and the clamp portion 3 rotates in such a manner that the clamp portion 3 opens from the inside toward the outside to clamp the portion to be clamped 8.

### TECHNICAL FIELD

The present invention relates to a clamping device and a transfer robot to transfer an object to be carried such as a wheeled platform.

### BACKGROUND ART

FIGS. 9 and 10 show related transfer robots. In particular, FIGS. 9 and 10 show a vertical multi-joint type robot and a horizontal multi-joint type robot respectively. The vertical multi-joint type robot 200 includes a foundation 201 grounded on a floor surface, a support portion 202 attached on the foundation 201 through a link mechanism (not shown), a first arm 204 attached to the support portion 202 by a link mechanism 203 in such a manner that the first arm 204 can rotate in a vertical direction, a second arm 206 attached to the first arm 204 by a link mechanism 205 in such a manner that the second arm 205 can rotate in a vertical direction, a hold portion 208 attached to the second arm 206 by a link mechanism 207 in such a manner that the hold portion 206 can rotate in a vertical direction, and a pin 209 attached to the hold portion 208. The first arm 204, the second arm 206, and the hold portion 208 are vertically moved by rotating the link mechanisms 203, 205 and 207. Further, the support portion 202 moves horizontally by the link mechanism disposed between the foundation 201 and the support portion 202.

Meanwhile, the horizontal multi-joint type robot 300 includes a foundation 301 grounded on a floor surface, a link mechanism 302 attached on the foundation 301, a first arm 303 attached by the link mechanism 302 in such a manner that the first arm 303 can rotate in a horizontal direction, a second arm 306 attached to the first arm 303 by the link mechanism 305 in such a manner that the second arm 306 can rotate in a horizontal direction, a hose 304 containing electrical wires connected to the second arm 306, and a cylinder 307 that is provided in the second arm 306 and moves vertically. The first arm 303 and the second arm 306 move horizontally by rotating the link mechanisms 302 and 305. An example of a publicly-known transfer robot that horizontally carries an object to be carried like the one described above is a transfer robot disclosed in Patent document 1.

Note that in such transfer robots, following methods can be conceivable as a related clamping mechanism used to carry a heavy object. 1) A method in which a hand pin is inserted into and fixed in a clamp hole provided in a wheeled platform. 2) A method in which a clamp portion (such as a bar) provided in a wheeled platform is sandwiched and fixed by a hand(s).

### [Patent Document 1]

### Japanese Utility Model Registration No. 3115497

### DISCLOSURE OF INVENTION

### Technical Problem

However, following problems arise when the above-described method is employed in a situation where variations in manufacturing accuracy/stop accuracy or the like of the wheeled platform are large. In the case of 1), a pin of a hand is inserted into a clamp hole of a wheeled platform or the like in a straight movement. However, the tip of the pin is tapered so that the variations are absorbed. Therefore, to increase the tolerable variations, it is necessary to increase the guiding of the clamp hole of the wheeled platform or the like. Further, errors in the stop position can be absorbed by increasing the guiding taper of the clamp hole. However, since both the pin and the hole become larger, it is very difficult to establish them when the available space is limited. Alternatively, it is necessary to provide an additional external positioning mechanism to improve the stop accuracy.

In the case of 2), the stroke of the clamp hand becomes larger. Therefore, when the safety needs to be taken into consideration, it is necessary to reduce the thrust or to attach a cover. However, a heavy object cannot be fixed with the reduced thrust. Further, if a cover is attached, the hand portion becomes larger. Therefore, it is very difficult to establish it when the available space is limited.

Since the wheeled platform or the like coexists with a worker(s) and is carried by the worker or on a conveyer having no positioning means, the stop position accuracy at the clamping position is poor. Further, if a positioning mechanism such as a conveyer is further added, the costs would become very high because a safety measure needs to be taken for the worker who coexists with the wheeled platform or the like. Therefore, the clamping has to be performed in a poor positioning accuracy state.

The present invention has been made to solve a problem like this, and an object thereof is to provide a clamping device capable of clamping an object even when the variations are large, and a wheeled platform.

### Technical Solution

To achieve the above-described object, a clamping device in accordance with the present invention includes: an actuator that moves straight; a link that extends in a direction perpendicular to a straight-movement direction of the actuator; and a clamp portion rotatably attached at both ends of the link, the clamp portion including a nail portion to clamp a portion to be clamped, wherein the actuator moves straight and the clamp portion rotates so that the portion to be clamped is clamped.

In the present invention, the actuator moves straight and the clamp portions thereby clamp the portion to be clamped from the inside, so that the portion to be clamped can be joined to the wheeled platform or the like. With the rotational mechanism of the clamp portions, it is possible to absorb large variations in the wheeled platform position and large variations in the hand portion position of the device on the transferring side without requiring a large space.

A transfer robot in accordance with the present invention includes: a foundation; a link mechanism provided in the foundation; a first arm attached to the foundation by the link mechanism such that the first arm can rotate in a horizontal direction; a caster that moves the first arm by using the link mechanism as axis, the caster being attached on a lower surface of the first arm; a hold portion provided on an upper surface of the first arm to hold an object to be carried; and a clamping device provided at an end of the hold potion, wherein the link mechanism includes: a motor; a first speed reduction mechanism that controls a rotation by the motor; and a second speed reduction mechanism that controls a turning movement of the first arm, the second speed reduction mechanism being connected to the first speed reduction mechanism, wherein the clamping device includes: an actuator that moves straight; a link that extends in a direction perpendicular to a straight-movement direction of the actuator; and a clamp portion rotatably attached at both ends of the link, the clamp portion including a nail portion to clamp a portion to be clamped, and wherein the actuator moves straight and the clamp portion rotates so that the portion to be clamped is clamped.

In the present invention, the caster(s) is further attached on the lower surface of the first arm to support the weight of the robot itself. In addition, an object to be carried is carried by turning the arm in a horizontal direction by the link mechanism. As a result, it is possible to use a low-power motor.

### Advantageous Effects

In accordance with the present invention, a clamping device capable of clamping an object even when variations are large, and a wheeled platform can be provided.

### BRIEF DESCRIPTION OF DRAWINGS

FIG. 1 shows a clamping device in accordance with an exemplary embodiment of the present invention;

FIG. 2 shows an aspect of an action of a clamping device before the clamping;

FIG. 3 shows an aspect of an action of a clamping device after the clamping;

FIG. 4 shows a transfer robot to which a clamping device in accordance with an exemplary embodiment of the present invention is attached;

FIG. 5 shows, similarly, a transfer robot to which a clamping device in accordance with an exemplary embodiment of the present invention is attached;

FIG. 6 shows, similarly, a transfer robot to which a clamping device in accordance with an exemplary embodiment of the present invention is attached;

FIG. 7 shows, similarly, a transfer robot to which a clamping device in accordance with an exemplary embodiment of the present invention is attached;

FIG. 8 shows, similarly, a transfer robot to which a clamping device in accordance with an exemplary embodiment of the present invention is attached;

FIG. 9 shows a related vertical multi-joint type robot; and

FIG. 10 shows a related horizontal multi-joint type robot.

### EXPLANATION OF REFERENCE

1 ACTUATOR
2 LINK
3 CLAMP PORTION
3a CLAMP NAIL
4 COVER
6 FULCRUM
7 PIN
8 PORTION TO BE CLAMPED
10 CLAMPING DEVICE
11 BASE PORTION
12a, 12b LINK PORTION
13 FRONT-END LINK PORTION
15a, 15b, 15c, 15d MOTOR
16a, 16b, 16c, 16d SPEED REDUCTION MECHANISM
17 FOUNDATION
18b, 18c, 18d, 18e SPEED REDUCTION MECHANISM
19b, 19c, 19d ARM
20b, 20c, 20d CASTER
31 WHEELED PLATFORM
32 CASTER
33 CLAMP BAR
100 TRANSFER ROBOT

### BEST MODE FOR CARRYING OUT THE INVENTION

Specific exemplary embodiments to which the present invention is applied are explained hereinafter with reference to the drawings. In these exemplary embodiments, the present invention is applied to a clamping device and a transfer robot to transfer an object to be carried such as a wheeled platform.

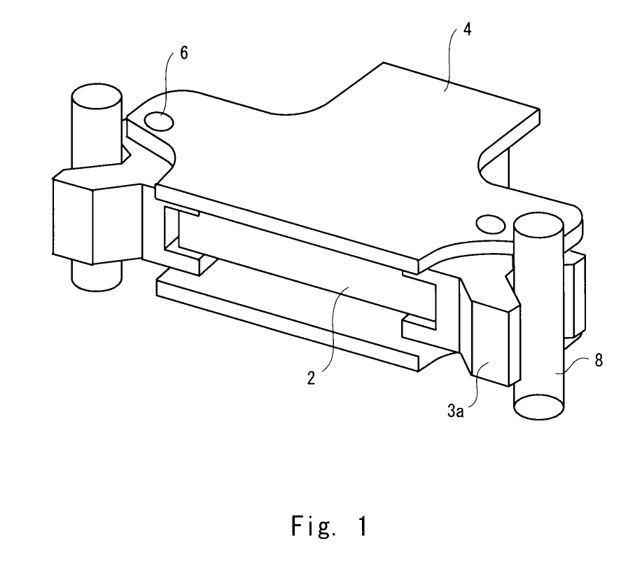

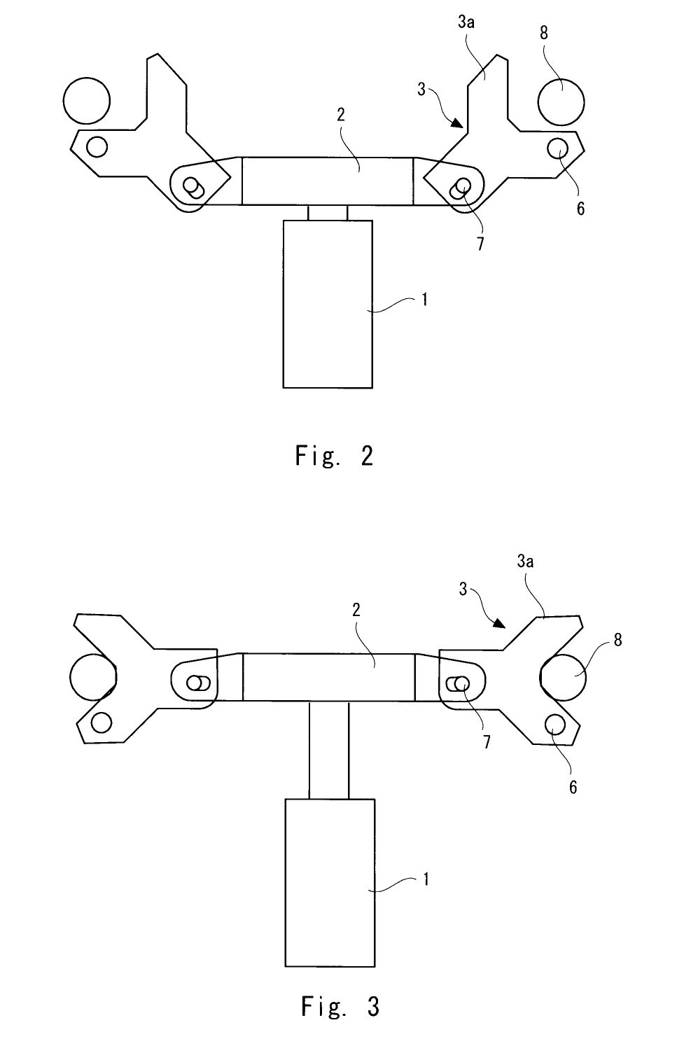

FIGS. 1 and 2 show a clamping device in accordance with this exemplary embodiment. The clamping device 10 is provided at an end of a transfer robot, which is described later, and used to join to a wheeled platform. The clamping device 10 includes an actuator 1 that moves straight, a link 2 that extends in a direction perpendicular to the straight movement direction of the actuator 1, clamp portions 3 attached to the both ends of the link 2, and a cover 4. Each of the clamp portions 3 includes a clamp nail 3a that clamps a portion to be clamped 8. The actuator 1 moves straight and the clamp portion 3 rotate so that the portion to be clamped 8 is clamped.

For example, two clamp bars (portion to be clamped) are provided in the wheeled platform or the like, and the clamp portions 3 of the clamping device hold and grasp these two clamp bars from the inside. It is possible to absorb large variations in the wheeled platform position and large variations in the hand position on the moving device side before the clamping.

Further, the actuator 1 in accordance with this exemplary embodiment may be a low-power actuator (e.g., 80 W or lower). The actuator 1 is fixed on the cover 4. Further, the link 2 is provided at the tip of the actuator 1. Furthermore, in each of the clamp portions 3, the clamp nail 3a is attached to the cover 4 in such a manner that the clamp nail 3a can rotate on a fulcrum 6. The clamp nail 3a is connected to a pin 7 fixed to the link 2 through an oblong hole. The oblong hole portion, which serves as the connection point between the link 2 and the clamp portion 3, acts as the point of effort. Further, the connection point between the portion to be clamped 8 and the clamp portion 3 acts as the point of action.

In this exemplary embodiment, the lateral force is relieved to the link 2 by rotating the clamp nail 3a, so that the load exerted on the actuator 1 can be reduced, thus enabling the thrust to be reduced. Various forces that would be exerted so that the clamping is disengaged including friction between the wheels of the wheeled platform and the floor surface and an inertial force during acceleration are exerted while the object is being carried. Therefore, the actuator 1 of the clamp portion needs to exert a force capable of coping with those forces.

Note that the clamping device 10 in accordance with this exemplary embodiment uses a rotational movement mechanism, and uses the straight-movement end (7) as the point of effort. Further, the clamp portions 3 are provided in such a manner that the clamp portions 3 can rotate on the fulcrums 6. As a result, it is possible to reduce the thrust of the actuator 1.

Further, by using the mechanism (pin or hand) that directly clamps an object with a straight movement, the required space is reduced. With the method in which one of the tapered clamp nails is used as the rotation center and clamping is performed by the rotational movement of the clamp nail with the straight-movement actuator, it is possible to clamp even a wheeled platform or the like having large position variations while making the hand perform positioning.

FIGS. 2 and 3 show aspects of an action of a clamping device. In particular, FIGS. 2 and 3 show aspects before and after clamping respectively. From the state shown in FIG. 2. the actuator 1 moves straight and the clamp portions 3 rotate by using the fulcrums 6 as references. As a result the portion to be clamped 8 can be clamped as shown in FIG. 3.

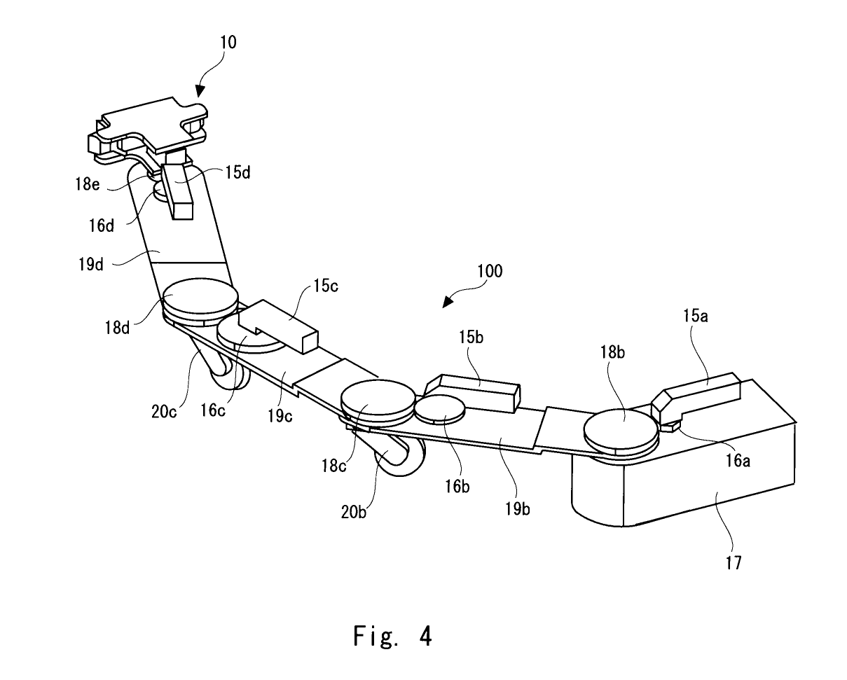

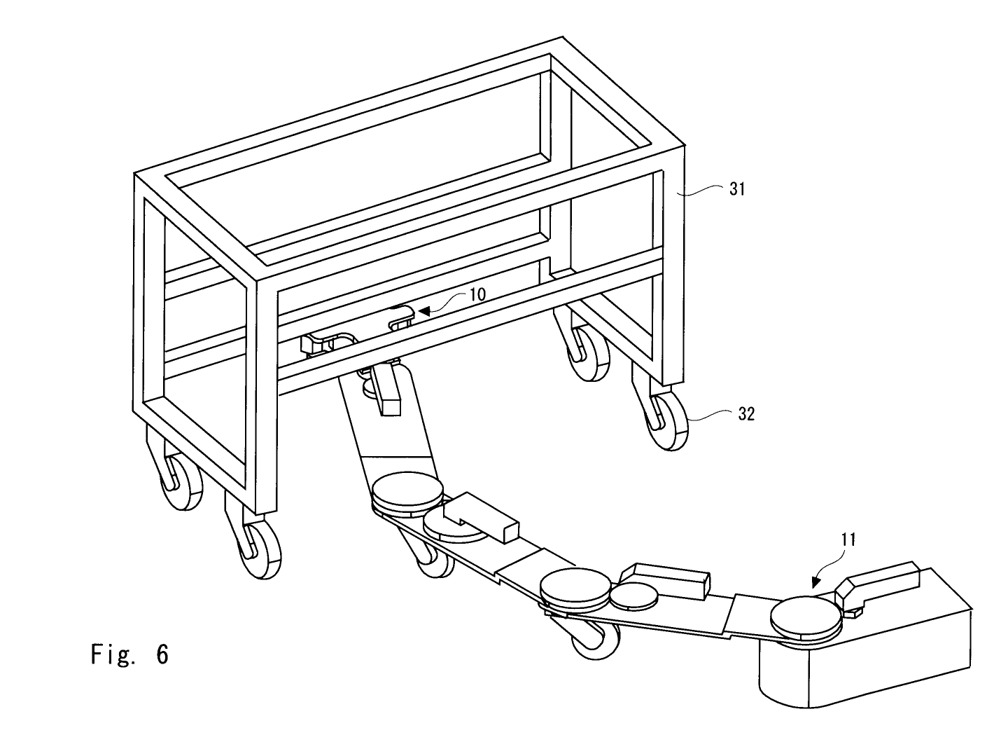

FIGS. 4 to 8 show a transfer robot to which the above-described clamping device is attached. The transfer robot 100 includes a base portion 11, link portions 12a and 12b, a front-end link portion 13, and a clamping device 10. The base portion 11 is fixed on the floor surface, and a wheeled platform 31 is held by the clamping device 10 provided at the front-end link portion 13. Then. each of the link portions 12a and 12b and the front-end link portion 13 rotates in a horizontal direction, so that the wheeled platform 31 can be transferred in a horizontal direction.

The base portion 11 includes a motor 15a, a first speed reduction mechanism 16a that is attached to the tip of motor 15a and rotates on a vertical axis by the motor 15a, and a foundation 17 on which the first speed reduction mechanism 16a is attached. The transfer robot 100 in accordance with this exemplary embodiment is configured so as to perform only two-dimensional movements, so that the load on the motor 15a can be reduced. For example, a low-power motor of 80 W or lower can be used.

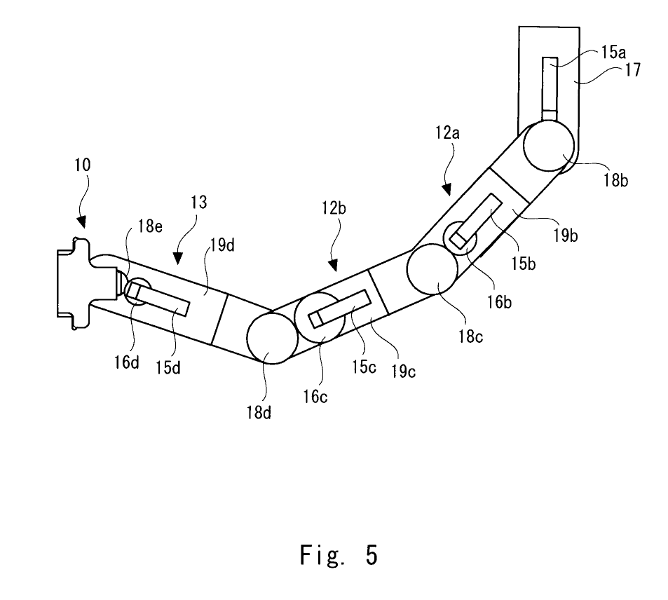

As shown in FIG. 5, the link portion 12a includes a second speed reduction mechanism 18b connected to the first speed reduction mechanism 16a of the base portion 11, an arm 19b that serves as a second arm, a motor 15b, a first speed reduction mechanism 16b that is rotated by the motor 15b, and a caster 20b that is attached on the lower surface of the arm 19b and supports and moves the arm 19b. The second speed reduction mechanism 18b is attached at one end of the upper surface of the arm 19b and the first speed reduction mechanism 16b is disposed at the other end of the arm 19b. Each of the first speed reduction mechanism and the second speed reduction mechanism is a mechanism to reduce the rotation speed of the motor, and constructed by a combination of a speed reducer, a gear box, a cogwheel(s), and the like. Similarly to the first speed reduction mechanism 16a, the second speed reduction mechanism 18b also rotates around a vertical axis in a horizontal direction. The motor 15a, the first speed reduction mechanism 16a, and the second speed reduction mechanism 18b constitute a link mechanism.

The first speed reduction mechanism 16a of the above-described base portion 11 is rotated by the motor 15a, and by this rotation, the second speed reduction mechanism 18b connected to the first speed reduction mechanism 16a is rotated. Note that the first speed reduction mechanism 16a and the second speed reduction mechanism 18b are configured in such a manner that their cogwheels mate with each other. The second arm 19b turns in a horizontal direction by rotating the second speed reduction mechanism 18b. The link portion 12b has a similar configuration as that of the link portion 12a.

The front-end link portion 13 includes a second speed reduction mechanism 18d, an arm 19d that serves as a first arm, a motor 15d, a first speed reduction mechanism 16d that is rotated by the motor 15d, and a caster 20d that is attached on the lower surface of the arm 19d and supports/moves the arm 19d. The second speed reduction mechanism 18b is attached at one end of the upper surface of the arm 19d. The front-end link portion 13 includes the clamping device 10 that connects to the first speed reduction mechanism 16d.

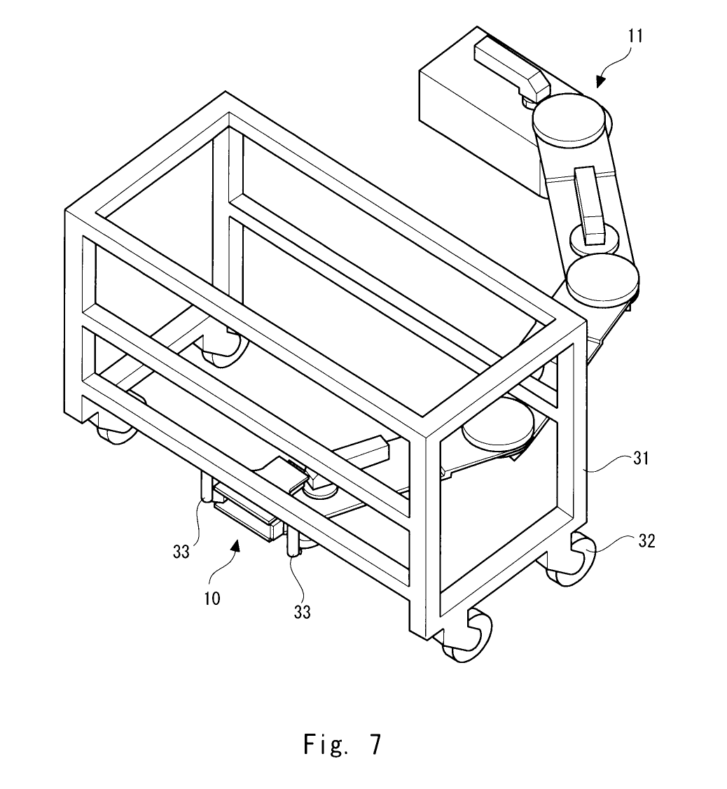

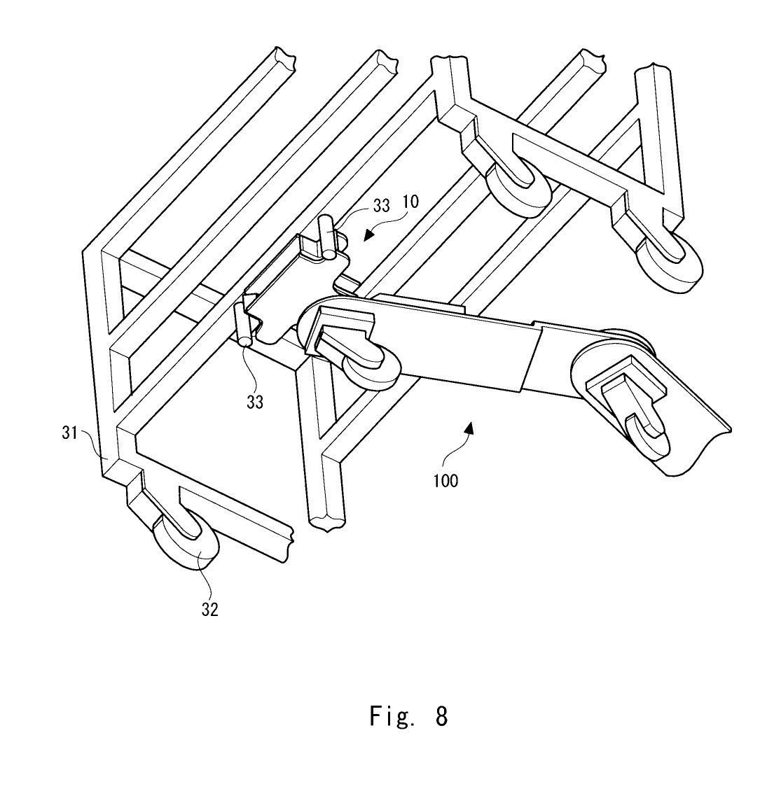

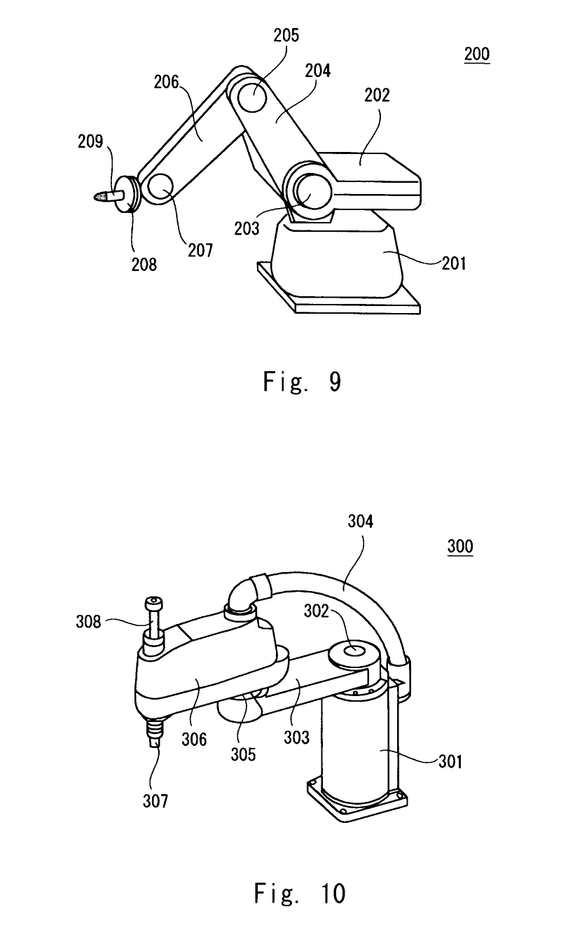

Further, as shown in FIGS. 7 and 8, the clamp portions 3 of the clamping device 10 rotate in such a manner that they open from the inside toward the outside to clamp the clamp bars 33 attached to the wheeled platform 31, so that the wheeled platform 31 and the clamping device 10 are joined to each other. The clamping device 10 can easily join to the wheeled platform 31, which includes wheels 32, just by providing the wheeled platform 31 with the clamp bars 33.

In this exemplary embodiment, clamping can be performed in a small space. Therefore, by disposing a bar(s) having a circular shape in cross-section in the portion to be clamped of the wheeled platform or the like, the transfer robot that can coexist with a worker can be realized with the same mechanism regardless of the shape of the wheeled platform and/or the shape of the object to be carried.

Note that the present invention is not limited to the above-described exemplary embodiments, and needless to say, various modifications can be made within the limits that do not depart from the spirit of the present invention.

### INDUSTRIAL APPLICABILITY

The present invention can be used in clamping devices and transfer robots to transfer an object to be carried such as a wheeled platform.

1. A clamping device comprising:
an actuator that moves straight;
a link that extends in a direction perpendicular to a straight-movement direction of the actuator; and
a clamp portion rotatably attached at both ends of the link, the clamp portion comprising a nail portion to clamp a portion to be clamped, wherein
the link comprises a fixed pin,
the nail portion comprises an oblong hole connected to the pin, and two tapered clamp nails, and
the actuator moves straight and the clamp portion rotates so that the portion to be clamped is clamped from inside and the link and the clamp portion are disposed in a straight line upon clamping of the portion to be clamped.

2. A transfer robot comprising:
a foundation;
a link mechanism provided in the foundation;
a first arm attached to the foundation by the link mechanism such that the first arm can rotate in a horizontal direction;
a caster that moves the first arm by using the link mechanism as an axis, the caster being attached on a lower surface of the first arm;
a hold portion provided on an upper surface of the first arm to hold an object to be carried; and
a clamping device provided at an end of the hold potion,
wherein the link mechanism comprises:
a motor;
a first speed reduction mechanism that controls a rotation by the motor; and
a second speed reduction mechanism that controls a turning movement of the first arm, the second speed reduction mechanism being connected to the first speed reduction mechanism,
wherein the clamping device comprises:
an actuator that moves straight;
a link that extends in a direction perpendicular to a straight-movement direction of the actuator; and
a clamp portion rotatably attached at both ends of the link, the clamp portion comprising a nail portion to clamp a portion to be clamped,
wherein the link comprises a fixed pin,
wherein the nail portion comprises an oblong hole connected to the pin, and two tapered clamp nails, and
wherein the actuator moves straight and the clamp portion rotates so that the portion to be clamped is clamped from inside and the link and the clamp portion are disposed in a straight line upon clamping of the portion to be clamped.

3. The clamping device according to claim 1, wherein the actuator moves straight and a connection point between the pin and the oblong hole acts as a point of effort, so that the clamp portion rotates and clamps the portion to be clamped by using one of the tapered clamp nails as a point of action.
